(19) United States
(12) Patent Application Publication
(10) Pub. No.: US 2011/0077919 A1
(43) Pub. Date: Mar. 31, 2011

(54) METHOD OF RECOGNIZING ACTIVITY ON BASIS OF SEMI-MARKOV CONDITIONAL RANDOM FIELD MODEL

(75) Inventors: Sung-Young LEE, Seongnam-si (KR); Young-Koo LEE, Daejeon-si (KR); La The VINH, Yongin-si (KR); Le Xuan HUNG, Yongin-si (KR); Ngo Quoc HUNG, Yongin-si (KR); Hyoung-Il KIM, Seongnam-si (KR); Man-Hyung HAN, Goyang-si (KR)

(73) Assignee: INDUSTRY ACADEMIC COOPERATION FOUNDATION OF KYUNG HEE UNIVERSITY, Yongin-si (KR)

(21) Appl. No.: 12/886,800

(22) Filed: Sep. 21, 2010

(30) Foreign Application Priority Data
Sep. 29, 2009 (KR) 10-2009-0092277

(51) Int. Cl. G06F 7/60; G06F 17/11

(52) U.S. Cl. 703/2

(57) ABSTRACT

A method of recognizing an activity on the basis of a semi-Markov conditional random field (CRF) model is provided. The method includes segmenting an input signal measured by an accelerometer to output frame sequences, extracting training feature vectors from the frame sequences, building a codebook containing kernel vectors from the training feature vectors; quantizing vector sequences into discrete symbol sequences, using linear chain semi-Markov CRF model to compute the likelihood of a label given its corresponding symbol sequence.

### CROSS REFERENCE TO RELATED APPLICATION

This application claims the benefit under 35 U.S.C. §119(a) of Korean Patent Application No. 10-2009-0092277, filed on Sep. 29, 2009, in the Korean Intellectual Property Office, the entire disclosure of which is incorporated herein by reference for all purposes.

### BACKGROUND

1. Field

The following description relates to a method of recognizing an activity on the basis of a semi-Markov conditional random field (CRF) model.

2. Description of the Related Art

Activity recognition is applied to various fields ranging from daily life to industry, and thus is becoming more important in people's lives. Activity recognition is frequently performed using many different sensors. Among these sensors, an accelerometer has been known as an effective sensor for measuring an activity because of low cost and low power consumption.

Lately, CRF models are used in sequential data modeling, thereby resulting in useful outcomes. These have been disclosed in reference document “Conditional random fields: Probabilistic models for segmenting and labeling sequence data” by John Lafferty, Andrew McCallum and Fernando Pereira.

However, such a conventional CRF cannot model the durations of activities nor the transitions over a long time period between activities.

To solve these problems, various modifications of the CRF have been proposed [Sunita Sarawagi, et al., 2004, and D. L. Vail, et al., 2001]. However, these modifications of the CRF have unrealistic complexity or do not completely solve the problems. For example, the first CRF proposed by John Lafferty, et al., in 2001 cannot model a duration of a state due to the Markov assumption.

Content disclosed by Sunita Sarawagi, et al. in 2004 to overcome this limitation is intended to lessen the Markov property using a semi-CRF. However, when activity recognition is applied, an unknown activity or null activity occurs between two expected activities or target activities, and thus the semi-CRF cannot capture an activity transition over a long time period either.

### SUMMARY

The following description relates to a solution to conventional problems, which is based on the extension of a semi-Markov conditional random field (CRF) model and has appropriate complexity.

According to an exemplary aspect, there is provided a method of recognizing an activity on the basis of a semi-Markov conditional random field (CRF) model, including: segmenting an input signal measured by an accelerometer to output frame sequences; extracting training feature vectors from the frame sequences; building a codebook containing kernel vectors from the training feature vectors; quantizing vector sequences into discrete symbol sequences; using linear chain semi-Markov CRF model to compute the likelihood of a label given its corresponding symbol sequence.

Additional aspects of the invention will be set forth in the description which follows, and in part will be apparent from the description, or may be learned by practice of the invention.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the aspects of the invention.

FIG. 1 illustrates a semi-Markov conditional random field (CRF) according to an exemplary embodiment of the present invention.

FIG. 2 shows graphs of bell-shaped probability functions for duration modeling according to an exemplary embodiment of the present invention.

FIG. 3 is a block diagram illustrating an example of activity recognition to which a semi-Markov CRF model according to an exemplary embodiment of the present invention is applied according to an exemplary embodiment of the present invention.

FIG. 4 is a block diagram illustrating a process of generating a kernel vector according to an exemplary embodiment of the present invention.

FIG. 5 is a flowchart illustrating a process of calculating Z according to an exemplary embodiment of the present invention.

### DETAILED DESCRIPTION

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

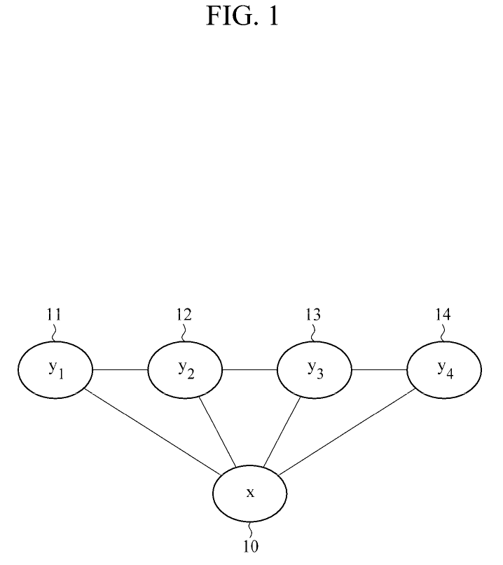

FIG. 1 illustrates a semi-Markov conditional random field (CRF) according to an exemplary embodiment of the present invention.

Heretofore, activity recognition solutions using a Markov model have not considered the correlation between activities and the durations of the activities and thus have not had high complexity.

An exemplary embodiment of the present invention relates to a semi-Markov CRF model having an algorithm whereby training and inference are simultaneously and rapidly performed to take the correlation between activities and the durations of the activities into consideration.

In other words, an exemplary embodiment of the present invention extends a semi-Markov CRF, thereby capturing an activity transition over a long time period while using the duration modeling performance of a conventional semi-Markov CRF.

To this end, a semi-Markov CRF with discontinuous state time is configured according to an exemplary embodiment of the present invention, and the semi-Markov CRF has a linear chain structure as shown in FIG. 1.

In FIG. 1, y₁, y₂, y₃ and y₄ denote states, and x denotes an input symbol value. In the semi-Markov CRF, a predetermined state is indicated by sᵢ=(yᵢ, bᵢ, eᵢ), and an i-th state is defined by the three parameters yᵢ, bᵢ and eᵢ. The parameter yᵢ relates to i-th state information, the parameter bᵢ relates to an i-th beginning time, and the parameter eᵢ relates to an i-th ending time.

The beginning time and ending time of an activity are separate from each other and satisfy Expression 1 below.

0<bᵢ≦eᵢ

eᵢ<bᵢ₊₁ [Expression 1]

A probability P(S|X) of a state sequence S given by an input sequence X is calculated by Expression 2 below.

$$P ( S \vert X ) = \frac{{\prod }_{i = 1}^{P} Ψ ( {s}_{i - 1} , {s}_{i} , X )}{{Z}_{X}} \\ {Z}_{X} = {\sum }_{{S}^{′}} {\prod }_{i = 1}^{{P}^{′}} Ψ ( {s}_{i - 1}^{′} , {s}_{i}^{′} , X ) \qquad [ Expression 2 ]$$

In Expression 2, Ψ denotes a probability of activity transition from sᵢ₋₁ to sᵢ.

Ψ is calculated by Expression 3 below.

$$Ψ ( {s}_{i - 1} , {s}_{i} , X ) = ( \begin{matrix}{e}^{{Q}^{T} ( {y}_{i - 1} , {y}_{i} )} \times \\ {e}^{{Q}^{D} ( {y}_{i} , {e}_{i} - {b}_{i} + 1 )} \times \\ {e}^{{Q}^{O} ( {y}_{i} , {b}_{1} , {e}_{i} )} \times \\ {e}^{{Q}^{O} ( IA , {e}_{i - 1} + 1 , {b}_{i} - 1 )}\end{matrix} ) \qquad [ Expression 3 ]$$

Q^{T}(y′, y), Q^{D}(y, d), Q^{O}(y, t₁, t₂), and Q^{O}(IA, t₁, t₂) in Expression 3 can be calculated by Expression 4 below.

$${Q}^{T} ( {y}^{′} , y ) = {w}^{T} ( {y}^{′} , y ) δ ( {y}_{t - 1} = {y}^{′} , {y}_{t} = y ) \\ δ ( X ) = \{ \begin{matrix}1 if X is true \\ 0 if X is false\end{matrix} \\ {Q}^{D} ( y , d ) = {w}^{D} ( y ) \frac{{( d - {m}_{y} )}^{2}}{2 {σ}_{y}^{2}} δ ( {y}_{t} = y ) \\ {Q}^{O} ( y , {t}_{1} , {t}_{2} ) = {\sum }_{t = {t}_{1}}^{{t}_{2}} {\sum }_{o} {w}^{O} ( y , o ) δ ( {y}_{t} = y , {x}_{t} = o ) \\ {Q}^{O} ( IA , {t}_{1} , {t}_{2} ) = {\sum }_{t = {t}_{1}}^{{t}_{2}} {\sum }_{o} {w}^{O} ( IA , o ) δ ( {y}_{t} = IA , {x}_{t} = 0 ) \qquad [ Expression 4 ]$$

In Expression 4, W^{D} is the weight of duration (D), W^{T} is the weight of activity transition (T), and W^{O} is the weight of observation (O). It is apparent that explicit duration information can be integrated in the model.

Also, in Expression 4, d is a duration variable, t₁ and t₂ are time variables, IA is a label of unknown activities, m_{y} is an average duration, and y is a label value of an expected activity having the average duration m_{y}.

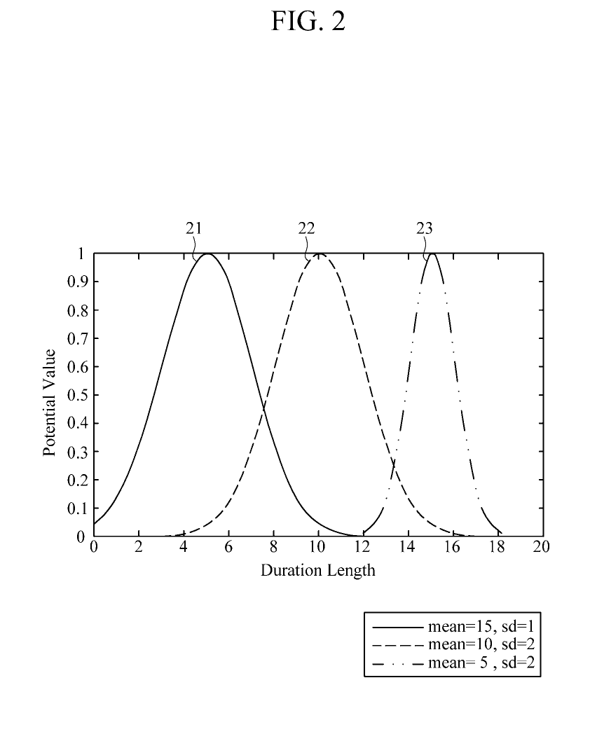

As can be seen from the above expressions, an exemplary embodiment of the present invention uses a bell-shaped probability function for duration modeling. The shape of the probability function is shown in FIG. 2. Graphs 21, 22 and 23 shown in FIG. 2 show probability function shapes having different means and standard deviations (sd) of durations (15, 1), (10, 2) and (5, 2), respectively.

Together with definition of the model, measurement of an increase or decrease of a parameter is performed using Expression 5, Expression 6 and Expression 7 below.

$$\begin{matrix} Gradient of Activity Transition Weight & [ Expression 5 ] \\ \frac{d {Z}_{X}}{d {w}^{T} ( {y}^{′} , y )} = {\sum }_{t = 1}^{T} γ ( {y}^{′} , t ) β ( y , t + 1 ) {e}^{{Q}^{T} ( {y}^{′} , y )} & \\ Gradient of Duration Weight & [ Expression 6 ] \\ \frac{d {Z}_{X}}{d {w}^{D} ( y )} = {\sum }_{d = 1}^{D} {\sum }_{t = 1}^{T} θ ( y , t , d ) , where θ ( y , t , d ) = ( \begin{matrix}λ ( y , t - 1 ) ζ ( y , t + d ) {e}^{G ( y , t , t + d - 1 )} + \\ ζ ( y , t + d ) {e}^{{Q}^{O} ( IA , 1 , t - 1 ) + G ( y , t , t + d - 1 )} + \\ λ ( y , t - 1 ) {e}^{G ( y , t , t + d - 1 ) + {Q}^{O} ( IA , t + d , T )} + \\ {e}^{{Q}^{O} ( IA , 1 , t - 1 ) + G ( y , t , t + d - 1 ) + {Q}^{O} ( IA , t + d , T )}\end{matrix} ) & \\ G ( y , t , t + d - 1 ) = {Q}^{O} ( y , t , t + d - 1 ) + {Q}^{D} ( y , d ) & \\ Gradient of Observation Weight & [ Expression 7 ] \\ \frac{d {Z}_{X}}{d {w}^{O} ( y , o )} = {\sum }_{{{i , t , d}_{{x}_{i} = o}}_{i ∈ [ t , t + d - 1 ]}} θ ( y , t , d ) , and \\ \frac{d {Z}_{X}}{d {w}^{O} ( IA , o )} = {\sum }_{{t = 1}_{{x}_{i} = o}}^{T} v ( t ) , where \\ v ( t ) = ( \begin{matrix}{\sum }_{{y}^{′}} {\sum }_{y} α ( {y}^{′} , t - 1 ) β ( y , t + 1 ) {e}^{{Q}^{T} ( {y}^{′} , y ) + {Q}^{O} ( IA , t , t )} + \\ α ( {y}^{′} , t - 1 ) {e}^{{Q}^{O} ( IA , t , T )} + \\ β ( y , t + 1 ) {e}^{{Q}^{O} ( IA , 1 , t )} + \\ {e}^{{Q}^{O} ( IA , 1 , T )}\end{matrix} ) & \end{matrix}$$

The functions α, λ, γ, β, η and ζ in Expression 5, Expression 6 and Expression 7 can be obtained by Expression 8 below.

$$α ( y , t ) = α ( y , t - 1 ) {e}^{{Q}^{O} ( IA , t , t )} + γ ( y , t ) \\ λ ( y , t ) = {\sum }_{{y}^{′}} α ( {y}^{′} , t ) {e}^{{Q}^{T} ( {y}^{′} , y )} \\ γ ( y , t ) = {\sum }_{d = 1}^{D} ( \begin{matrix}λ ( y , t - d ) {e}^{G ( y , t - d + 1 , t )} + \\ {e}^{{Q}^{O} ( IA , 1 , t - d ) + G ( y , t - d + 1 , t )}\end{matrix} ) \\ β ( y , t ) = β ( y , t + 1 ) {e}^{{Q}^{O} ( IA , t , t )} + η ( y , t ) \\ η ( y , t ) = {\sum }_{d = 1}^{D} ( \begin{matrix}ζ ( y , t + d ) {e}^{G ( y , t , t + d - 1 )} + \\ {e}^{G ( y , t , t + d - 1 ) + {Q}^{O} ( IA , t + d , T )}\end{matrix} ) \\ ζ ( y , t ) = {\sum }_{{y}^{′}} β ( {y}^{′} , t ) {e}^{{Q}^{T} ( y , {y}^{′} )} \qquad [ Expression 8 ]$$

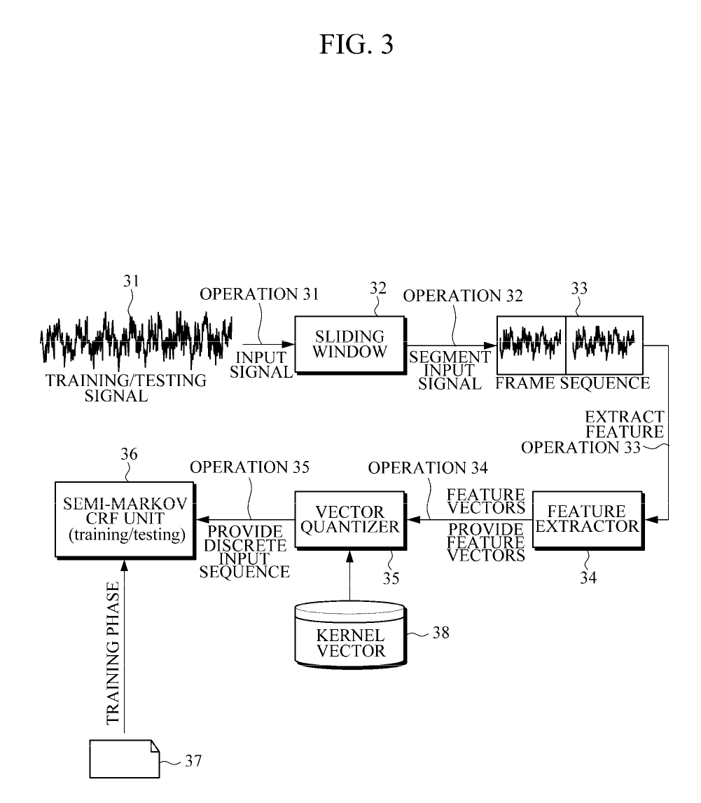

FIG. 3 is a block diagram illustrating an example of activity recognition to which a semi-Markov CRF model according to an exemplary embodiment of the present invention is applied according to an exemplary embodiment of the present invention.

When an input signal 31 for training or testing measured by an accelerometer is input to a sliding window 32 (operation 31), the sliding window 32 segments the input signal into frame sequences 33 (operation 32). The sliding window 32 segments the input signal 31 using the Hamming function. The Hamming function is frequently used for filter design, and serves to receive a factor which is a number and segment a signal.

A feature extractor 34 extracts feature vectors from the segmented frame sequences 33 (operation 33). The extracted feature vectors are provided to a vector quantizer 35 (operation 34).

The vector quantizer 35 receives and combines the feature vectors with a kernel vector 38, thereby constructing a discrete input sequence (operation 35). The discrete input sequence is provided to a semi-Markov CRF unit 36. In a training phase, a manual state label set is required when there is an additional input to the semi-Markov CRF unit 36.

On the basis of the discrete input sequence received from the vector quantizer 35, the semi-Markov CRF unit 36 can capture an activity transition by Expression 1 to Expression 8 and output a recognition result.

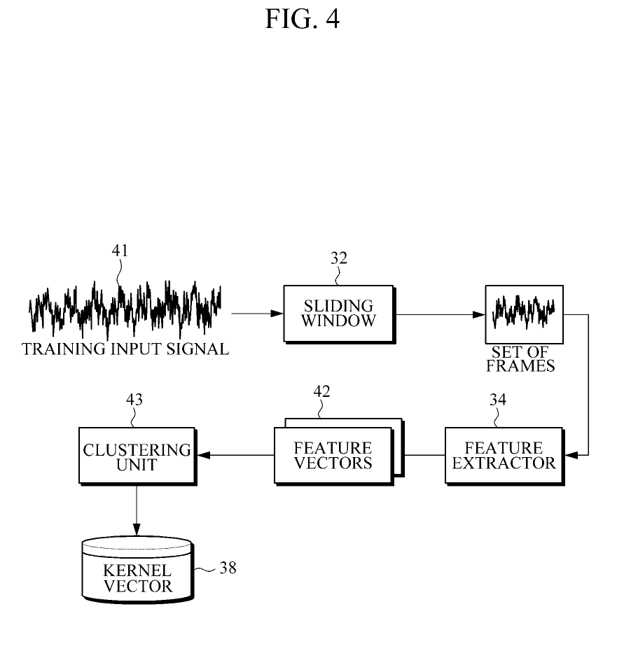

Meanwhile, the kernel vector 38 input to the vector quantizer 35 together with the feature vector is generated through a separate process, which will be described below with reference to FIG. 4.

When a training input signal 41 is input to the sliding window 32, the sliding window 32 generates one set of frames from the input signal and provides the generated frames to the feature extractor 34. The feature extractor 34 extracts feature vectors 42 from the one set of frames.

The extracted feature vectors 42 are provided to a clustering unit 43, and the clustering unit 43 collects the input feature vectors 42 to generate the kernel vector 38.

The generated kernel vector 38 is provided to the vector quantizer 35 of FIG. 3, and in the vector quantizer 35, feature vectors are quantized by the most similar kernel vector.

As a result, in an exemplary embodiment of the present invention, inference from sequential feature vectors and training by kernel vectors are simultaneously and rapidly performed, so that an activity transition recognition result can be output.

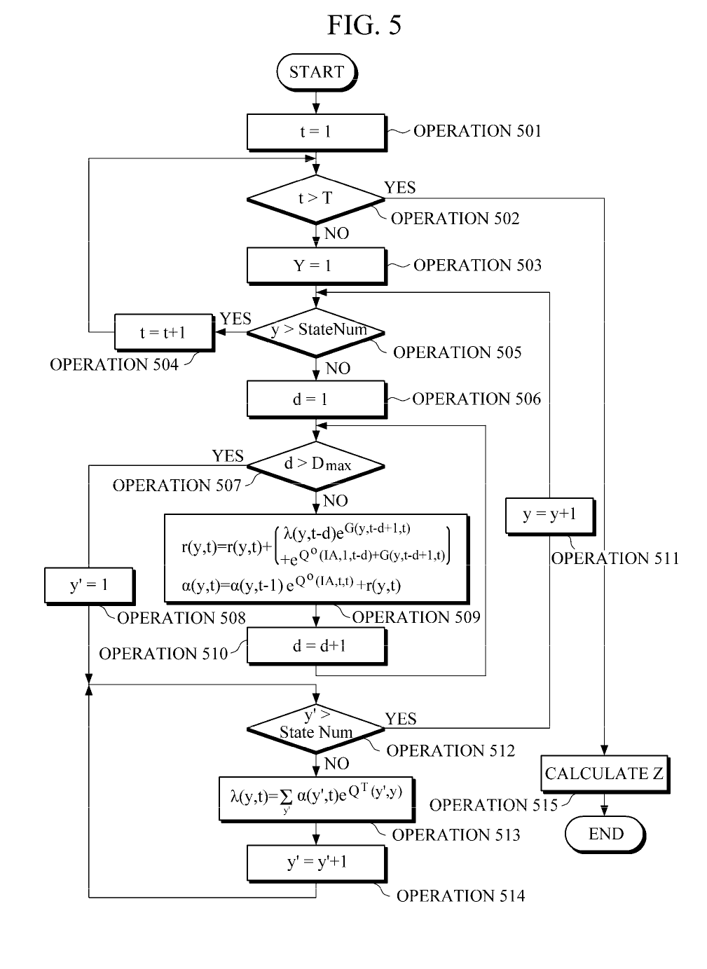

FIG. 5 is a flowchart illustrating a process of calculating Z of Expression 2 according to an exemplary embodiment of the present invention.

The probability P(S|X) of a label state sequence can be calculated by Expression 2 as mentioned above. See Expression 2.

$$P ( S \vert X ) = \frac{{\prod }_{i - 1}^{P} Ψ ( {s}_{i - 1} , {s}_{i} , X )}{{Z}_{X}}$$

As mentioned above, the function P(S|X) requires the function Zₓ, which is calculated by the following equation:

$${Z}_{X} = {\sum }_{{S}^{′}} {\prod }_{i = 1}^{{P}^{′}} Ψ ( {s}_{i - 1}^{′} , {s}_{i}^{′} , X ) .$$

A process of calculating the function Zₓ is illustrated in a flowchart of FIG. 5.

Referring to FIG. 5, when a current time t exceeds a reference value T, Z is directly calculated. On the other hand, when the current time t is the reference value T or less, the function ψ is calculated for each time band to sequentially perform ΣΠ operation.

To this end, first, operations 501, 502, and 504 constitute a loop with the variable t. Also, operations 506, 507, and 510 constitute a loop with a variable d, and operations 508, 512, and 514 constitute a loop with a variable y′. In operations 509 and 513, the functions α, γ and λ are calculated by Expression 8, and in operation 515, the standardized factor Z is calculated.

As apparent from the above description, in activity recognition using an accelerometer according to an exemplary embodiment of the present invention, training and inference are simultaneously performed in a semi-Markov CRF. Thus, an activity transition can be effectively captured for a long duration.

It will be apparent to those skilled in the art that various modifications and variations can be made in the present invention without departing from the spirit or scope of the invention. Thus, it is intended that the present invention covers the modifications and variations of this invention provided they come within the scope of the appended claims and their equivalents.

What is claimed is:

1. A method of recognizing an activity on the basis of a semi-Markov conditional random field (CRF) model, comprising:
segmenting an input signal measured by an accelerometer to output frame sequences;
extracting a feature vector from the frame sequences;
building a codebook containing the kernel vectors from the extracted feature vectors in the previous step;
quantizing the feature vector using a kernel vector most similar to the feature vector to output a discrete input sequence; and
using a linear chain semi-Markov CRF model to compute the likelihood of a state sequence S given its corresponding symbol sequence X, P(S|X).

2. The method of claim 1, wherein the segmenting of the input signal includes segmenting the input signal using a Hamming function.

3. The method of claim 1, wherein when yᵢ is a parameter related to i-th state information, bᵢ is a parameter related to an i-th beginning time, eᵢ is a parameter related to an i-th ending time, 0<bᵢ≦eᵢ, and eᵢ<bᵢ₊₁, and the specific state sᵢ is defined to be (yᵢ, bᵢ, eᵢ).

4. The method of claim 3, wherein the probability P(S|X) of the state sequence is calculated by
$$P ( S \vert X ) = \frac{{\prod }_{i - 1}^{P} Ψ ( {s}_{i - 1} , {s}_{i} , X )}{{Z}_{X}} ,$$
and the functions Zₓ and ψ are calculated by
$${Z}_{X} = {\sum }_{{S}^{′}} {\prod }_{i = 1}^{{P}^{′}} Ψ ( {s}_{i - 1}^{′} , {s}_{i}^{′} , X )$$
$$Ψ ( {s}_{i - 1} , {s}_{i} , X ) = ( \begin{matrix}{e}^{{Q}^{T} ( {y}_{i - 1} , {y}_{i} )} \times \\ {e}^{{Q}^{D} ( {y}_{i} , {e}_{i} - {b}_{i} + 1 )} \times \\ {e}^{{Q}^{O} ( {y}_{i} , {b}_{1} , {e}_{i} )} \times \\ {e}^{{Q}^{O} ( IA , {e}_{i - 1} + 1 , {b}_{i} - 1 )}\end{matrix} )$$
$${Q}^{T} ( {y}^{′} , y ) = {w}^{T} ( {y}^{′} , y ) δ ( {y}_{t - 1} = {y}^{′} , {y}_{t} = y )$$
$$δ ( X ) = \{ \begin{matrix}1 if X is true \\ 0 if X is false\end{matrix} \\ {Q}^{D} ( y , d ) = {w}^{D} ( y ) \frac{{( d - {m}_{y} )}^{2}}{2 {σ}_{y}^{2}} δ ( {y}_{t} = y ) \\ {Q}^{O} ( y , {t}_{1} , {t}_{2} ) = {\sum }_{t = {t}_{1}}^{{t}_{2}} {\sum }_{o} {w}^{O} ( y , o ) δ ( {y}_{t} = y , {x}_{t} = o ) \\ {Q}^{O} ( IA , {t}_{1} , {t}_{2} ) = {\sum }_{t = {t}_{1}}^{{t}_{2}} {\sum }_{o} {w}^{O} ( IA , o ) δ ( {y}_{t} = IA , {x}_{t} = 0 )$$
where W^{D} is a weight of duration, W^{T} is a weight of activity transition, W^{O} is a weight of observation, d is a duration variable, t₁ and t₂ are time variables, IA is a label of unknown activities, m_{y} is an average duration, and y is a label value of an expected activity having the average duration m_{y}.

5. The method of claim 4, wherein when
$$α ( y , t ) = α ( y , t - 1 ) {e}^{{Q}^{O} ( IA , t , t )} + γ ( y , t )$$
$$λ ( y , t ) = {\sum }_{{y}^{′}} α ( {y}^{′} , t ) {e}^{{Q}^{T} ( {y}^{′} , y )}$$
$$γ ( y , t ) = {\sum }_{d = 1}^{D} ( \begin{matrix}λ ( y , t - d ) {e}^{G ( y , t - d + 1 , t )} + \\ {e}^{{Q}^{O} ( IA , 1 , t - d ) + G ( y , t - d + 1 , t )}\end{matrix} )$$
$$β ( y , t ) = β ( y , t + 1 ) {e}^{{Q}^{O} ( IA , t , t )} + η ( y , t )$$
$$η ( y , t ) = {\sum }_{d = 1}^{D} ( \begin{matrix}ζ ( y , t + d ) {e}^{G ( y , t , t + d - 1 )} + \\ {e}^{G ( y , t , t + d - 1 ) + {Q}^{O} ( IA , t + d , T )}\end{matrix} )$$
$$ζ ( y , t ) = {\sum }_{{y}^{′}} β ( {y}^{′} , t ) {e}^{{Q}^{T} ( y , {y}^{′} )}$$
a gradient of the duration weight W^{D} is calculated by
$$\begin{matrix} \frac{d {Z}_{X}}{d {w}^{D} ( y )} = {\sum }_{d = 1}^{D} {\sum }_{t = 1}^{T} θ ( y , t , d ) , where θ ( y , t , d ) = ( \begin{matrix}λ ( y , t - 1 ) ζ ( y , t + d ) {e}^{G ( y , t , t + d - 1 )} + \\ ζ ( y , t + d ) {e}^{{Q}^{O} ( IA , 1 , t - 1 ) + G ( y , t , t + d - 1 )} + \\ λ ( y , t - 1 ) {e}^{G ( y , t , t + d - 1 ) + {Q}^{O} ( IA , t + d , T )} + \\ {e}^{{Q}^{O} ( IA , 1 , t - 1 ) + G ( y , t , t + d - 1 ) + {Q}^{O} ( IA , t + d , T )}\end{matrix} ) \\ G ( y , t , t + d - 1 ) = {Q}^{O} ( y , t , t + d - 1 ) + {Q}^{D} ( y , d ) ,\end{matrix}$$
a gradient of the activity transition weight W^{T} is calculated by
$$\frac{d {Z}_{X}}{d {w}^{T} ( {y}^{′} , y )} = {\sum }_{t = 1}^{T} γ ( {y}^{′} , t ) β ( y , t + 1 ) {e}^{{Q}^{T} ( {y}^{′} , y )} ,$$
and a gradient of the observation weight W^{O} is calculated by
$$\frac{d {Z}_{X}}{d {w}^{O} ( y , o )} = {\sum }_{{{i , t , d}_{{x}_{i} = o}}_{i ∈ [ t , t + d - 1 ]}} θ ( y , t , d ) , and$$
$$\frac{d {Z}_{X}}{d {w}^{O} ( IA , o )} = {\sum }_{{t = 1}_{{x}_{i} = o}}^{T} v ( t ) , where$$
$$v ( t ) = ( \begin{matrix}{\sum }_{{y}^{′}} {\sum }_{y} α ( {y}^{′} , t - 1 ) β ( y , t + 1 ) {e}^{{Q}^{T} ( {y}^{′} , y ) + {Q}^{O} ( IA , t , t )} + \\ α ( {y}^{′} , t - 1 ) {e}^{{Q}^{O} ( IA , t , T )} + \\ β ( y , t + 1 ) {e}^{{Q}^{O} ( IA , 1 , t )} + \\ {e}^{{Q}^{O} ( IA , 1 , T )}\end{matrix} ) .$$
